(19) United States
(12) Patent Application Publication
(10) Pub. No.: US 2025/0273934 A1
(43) Pub. Date: Aug. 28, 2025

(54) CARBON DIOXIDE GAS INSULATED SWITCHGEAR

(71) Applicant: G & W ELECTRIC COMPANY, Bolingbrook, IL (US)

(72) Inventors: Ian Mainwaring, Chicago, IL (US); Arturas Dauksas, Oak Lawn, IL (US); Traci Yeaton, Naperville, IL (US); Sean Murphy, St. Petersburg, FL (US); Karen Mann, Schaumburg, IL (US); Sterlin Cochran, Naperville, IL (US); Kennedy Darko, Bolingbrook, IL (US); Eric Joseph Campbell, Markham, IL (US); Alonso Adrián de Ojeda Yáñez, San Luis Potosí (MX)

(21) Appl. No.: 19/061,797

(22) Filed: Feb. 24, 2025

Related U.S. Application Data
(60) Provisional application No. 63/557,317, filed on Feb. 23, 2024.

(51) Int. Cl. H02B 13/055

(52) U.S. Cl. CPC H02B 13/055

(57) ABSTRACT

A switchgear apparatus may include a cylindrical housing defining a housing interior filled with carbon dioxide, an electrical switch supported within the housing, the electrical switch including a chamber communicating the housing interior and a pair of contacts within the chamber, the pair of contacts including a stationary contact and a movable contact, and a crankshaft coupled to the movable contact such that the movable contact is configured to translate linearly relative to the stationary contact in response to rotation of the crankshaft.

### FIELD

The present disclosure relates to electrical switchgear.

### BACKGROUND

Electrical switchgear is used to selectively open and close electrical connections in electrical power generation, transmission, and distribution systems. Gas-insulated electrical switchgear typically uses sulfur hexafluoride (SF6) contained within a tank to surround and insulate the high voltage components of the switchgear.

### SUMMARY

SF6 is known to be a greenhouse gas that contributes to global warming, and its use as an arc-quenching insulating gas in switchgear is being phased out in some markets and regions. Accordingly, a need exists for switchgear insulated with alternative (i.e., non-SF6) gases, and particularly natural origin gases, such as carbon dioxide (“CO2”), Nitrogen, atmospheric air, or the like. CO2 or other non-SF6 gases can be used as a replacement for SF6 as the insulating gas, however, such non-SF6 gases may need to be contained in the switchgear housing at a higher pressure than if SF6 were used. In addition, non-SF6 gases may be less effective at arc-quenching than SF6 in rotary switches. CO2 has been found effective for arc-quenching in linear switchgear, but linear switchgear often has a larger footprint than rotary switchgear. Due to its larger footprint, typical linear switchgear may not fit into an existing location (e.g., cabinet, underground vault, etc.) for a user who wishes to replace rotary switchgear insulated using SF6 with switchgear insulated using CO2 or other non-SF6 gases.

Accordingly, the present disclosure provides, among other things, a switchgear apparatus insulated with a non-SF6 gas, such as CO2, and enclosed within a cylindrical housing. The switchgear apparatus includes linearly movable contacts actuated via a rotary mechanism. This may advantageously allow the switchgear apparatus to fit into an existing rotary switchgear installation.

For example, in some aspects, the techniques described herein relate to a switchgear apparatus including: a cylindrical housing defining a housing interior that contains carbon dioxide; an electrical switch supported within the housing, the electrical switch including a chamber communicating the housing interior and a pair of contacts within the chamber, the pair of contacts including a stationary contact and a movable contact; a crankshaft coupled to the movable contact such that the movable contact is configured to translate linearly relative to the stationary contact in response to rotation of the crankshaft.

In some aspects, the techniques described herein relate to a switchgear apparatus, wherein the electrical switch is a first electrical switch, and wherein the switchgear apparatus further includes a second electrical switch supported within the housing.

In some aspects, the techniques described herein relate to a switchgear apparatus, wherein the crankshaft is a first crankshaft, and wherein the switchgear apparatus further includes a second crankshaft coupled to a movable contact of the second electrical switch.

In some aspects, the techniques described herein relate to a switchgear apparatus, wherein the first crankshaft is rotatable in a first direction to move the movable contact of the first electrical switch away from the stationary contact of the first electrical switch, and wherein the second crankshaft is rotatable in a second direction opposite the first direction to move the movable contact of the second electrical switch away from a stationary contact of the second electrical switch.

In some aspects, the techniques described herein relate to a switchgear apparatus, wherein the housing is filled with carbon dioxide to a gauge pressure of at least 15 psi.

In some aspects, the techniques described herein relate to a switchgear apparatus, wherein the housing is filled with carbon dioxide to a gauge pressure of at least 20 psi.

In some aspects, the techniques described herein relate to a switchgear apparatus including: an apparatus housing including a base casting coupled to a shell, a top plate, and a base plate, the top plate and base plate coupled to opposite ends of the base casting; a crankshaft rotationally supported between the top plate and the base plate; an operation assembly coupled to the base plate and configured to provide a rotational output to the crankshaft; a plurality of chambers coupled to the base casting and extending from the base casting away from the shell, each of the chambers containing an insulating medium; a top support coupled to distal ends of the chambers, the top support configured to seal the distal ends of the chambers; a plurality of contact pairs supported in each chamber, each contact pair including a stationary contact and a movable contact, each stationary contact is coupled to the top support and each movable contact is coupled to the crankshaft, each movable contact configured to translate linearly along the chamber in response to rotation of the crankshaft.

In some aspects, the techniques described herein relate to a switchgear apparatus, wherein the operation assembly includes an input shaft coupled to the crankshaft and configured to provide the rotational output to the crankshaft, the input shaft configured to receive a rotational input from an operator, the rotational input having a first direction.

In some aspects, the techniques described herein relate to a switchgear apparatus, wherein the operation assembly further includes a transmission assembly configured to receive the rotational input in the first direction and provide the rotational output to the crankshaft in a second direction opposite to the first direction.

In some aspects, the techniques described herein relate to a switchgear apparatus, wherein the transmission assembly includes a pinion coupled to the input shaft and a driven gear coupled to an output shaft, the output shaft coupled to the crankshaft.

In some aspects, the techniques described herein relate to a switchgear apparatus including: a housing defining a housing interior containing an insulating medium; a lid coupled to the housing and the lid defining an interior; a plurality of connectors extending from the lid into the interior; and an electrical switch coupled to the lid and electrically coupled to the connectors, the electrical switch including an apparatus housing including a base casting coupled to a shell, a top plate, and a base plate, the top plate and base plate coupled to opposite ends of the base casting, a crankshaft rotationally supported between the top plate and the base plate, an operation assembly coupled to the base plate and configured to provide a rotational output to the crankshaft, a plurality of chambers coupled to the base casting and extending from the base casting away from the shell, each of the chambers communicating the housing interior, a top support coupled to distal ends of the chambers, the top support configured to seal the distal ends of the chambers, and a plurality of contact pairs supported in each chamber, each contact pair including a stationary contact and a movable contact, each stationary contact is coupled to the top support and each movable contact is coupled to the crankshaft, each movable contact configured to translate linearly along the chamber in response to rotation of the crankshaft.

In some aspects, the techniques described herein relate to a switchgear apparatus, wherein the operation assembly includes a transmission assembly configured to receive a rotational input in a first direction and provide the rotational output to the crankshaft in a second direction opposite to the first direction.

In some aspects, the techniques described herein relate to a switchgear apparatus, wherein the transmission assembly includes a pinion coupled to an input shaft and a driven gear coupled to an output shaft, the output shaft coupled to the crankshaft.

Other features and aspects of the disclosure will become apparent by consideration of the following detailed description and accompanying drawings.

### BRIEF DESCRIPTION OF THE DRAWINGS

FIG. 1 is a perspective view of an embodiment of an electrical switchgear apparatus.

FIG. 2 is a side view of an actuator of the electrical switchgear apparatus of claim 1.

FIG. 3 is a perspective view of an electrical switchgear apparatus of FIG. 1, including a lockout assembly.

FIG. 4 is a perspective view of another embodiment of an electrical switchgear apparatus, including a lockout assembly.

FIG. 5 is a perspective view of the electrical switchgear apparatus of FIG. 1, including the electrical switch.

FIG. 6 is an exploded view of an embodiment of an electrical switch.

FIG. 7 is a perspective view of the electrical switch of FIG. 6.

FIG. 8 is a side view of the electrical switch of FIG. 6.

FIG. 9 is a section view of the electrical switch of FIG. 6.

FIG. 10 is a perspective view of an embodiment of an operation mechanism.

FIG. 11 is a perspective view of an embodiment of the spring assembly.

FIG. 12 is a perspective view of the spring assembly of FIG. 11.

FIG. 13 is a section view of the spring assembly of FIG. 11.

FIG. 14 is a perspective view of another embodiment of an operation mechanism, including a transmission assembly.

FIG. 15 is a perspective view of the operation mechanism of FIG. 14.

FIG. 16 is a perspective view of a portion of the electrical switch of FIG. 6.

FIG. 17 is a perspective view of an embodiment of a crankshaft.

FIG. 18 is a circuit diagram of an embodiment of a switchgear apparatus.

FIG. 19 is an end view of a portion of an embodiment of a switchgear apparatus including the circuit of FIG. 18.

FIG. 20 is a perspective view of a portion of the switchgear apparatus of FIG. 19.

FIG. 21 is a circuit diagram of an embodiment of a switchgear apparatus.

FIG. 22 is an end view of a portion of an embodiment of a switchgear apparatus including the circuit of FIG. 21.

FIG. 23 is a perspective view of a portion of the switchgear apparatus of FIG. 22.

FIG. 24 is a circuit diagram of an embodiment of a switchgear apparatus.

FIG. 25 is an end view of a portion of an embodiment of a switchgear apparatus including the circuit of FIG. 24.

FIG. 26 is a perspective view of a portion of the switchgear apparatus of FIG. 25.

FIG. 27 is a circuit diagram of an embodiment of a switchgear apparatus.

FIG. 28 is an end view of a portion of an embodiment of a switchgear apparatus including the circuit of FIG. 27.

FIG. 29 is a perspective view of a portion of the switchgear apparatus of FIG. 28.

FIG. 30 is a circuit diagram of an embodiment of a switchgear apparatus.

FIG. 31 is an end view of a portion of an embodiment of a switchgear apparatus including the circuit of FIG. 30.

FIG. 32 is a perspective view of a portion of the switchgear apparatus of FIG. 31.

FIG. 33 is a circuit diagram of an embodiment of a switchgear apparatus.

FIG. 34 is an end view of a portion of an embodiment of a switchgear apparatus including the circuit of FIG. 33.

FIG. 35 is a perspective view of a portion of the switchgear apparatus of FIG. 34.

FIG. 36 is a circuit diagram of an embodiment of a switchgear apparatus.

FIG. 37 is an end view of a portion of an embodiment of a switchgear apparatus including the circuit of FIG. 36.

FIG. 38 is a perspective view of a portion of the switchgear apparatus of FIG. 37.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

### DETAILED DESCRIPTION

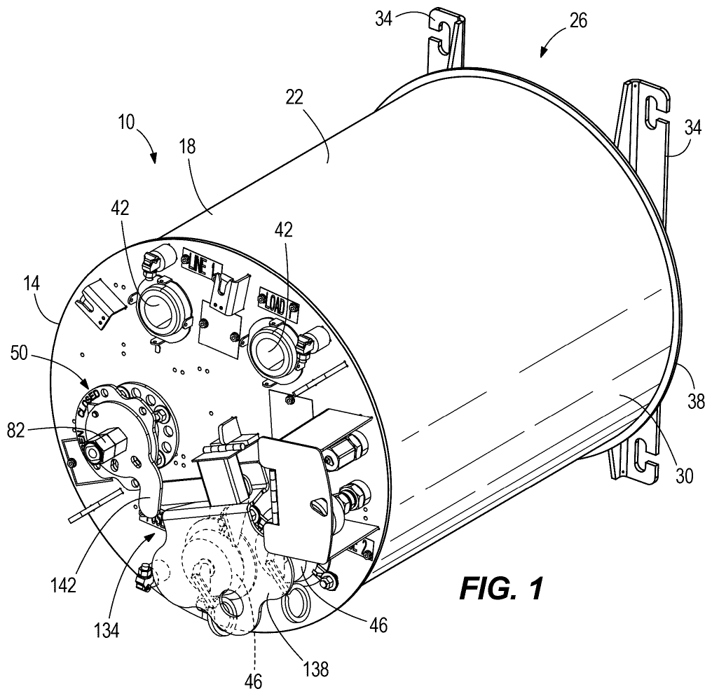

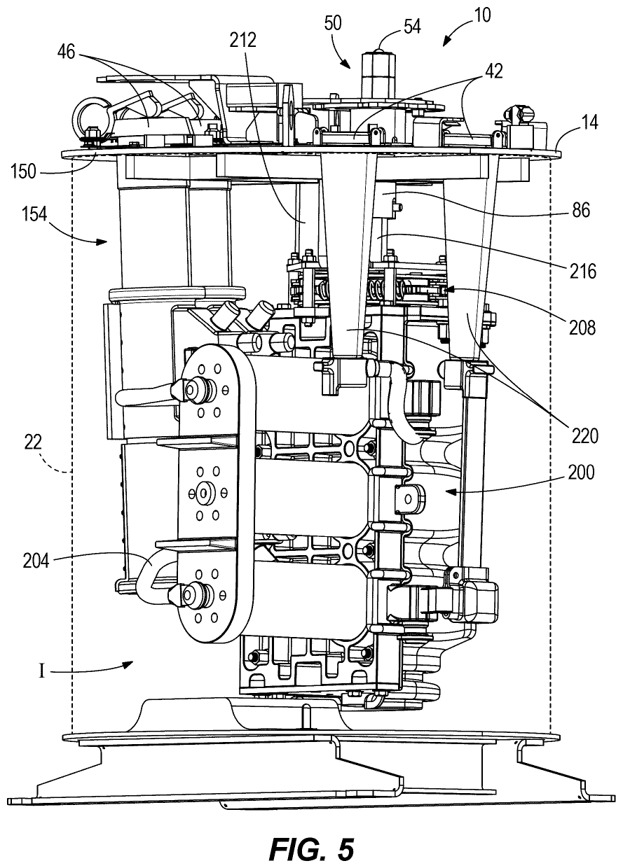

FIG. 1 illustrates an embodiment of an electrical switchgear apparatus 10 that includes a lid 14 coupled to the first end 18 of a substantially cylindrical switchgear housing 22. The electrical switchgear apparatus 10 also includes a foundation 26 coupled to a second end 30 of the housing 22 opposite the first end 18. The illustrated foundation 26 includes supports (e.g., rails) 34 coupled to a circular base plate 38; however, the foundation 26 may have other configurations to suit a particular installation location. The lid 14, housing 22, and circular base plate 38 together define a housing interior I (FIG. 5) in which an insulating medium (e.g., CO2 gas, a combination of CO2 and oxygen (“O2”), and/or other non-SF6 gases) is contained. The housing interior I has a volume of less than 500 liters, and may have a volume that is less than 300 liters, for instance, a volume that is 150 liters, or less.

With continued reference to FIG. 1, the illustrated switchgear apparatus 10 includes line couplers 42 on the lid 14, to which supply and load lines of the supply and load circuits may be coupled. In some embodiments, the switchgear apparatus 10 may include two, four, six, or more line couplers depending on the number of phases and ways present in the circuit in which the electrical switchgear apparatus 10 is used. The embodiment of FIG. 1 and other embodiments described below may include input couplers 46 that may receive or otherwise connect to a fuse, a voltage tap, or other control or diagnostic structure therein.

As described in greater detail below, embodiments of the switchgear apparatus 10 described and illustrated herein may include, among other things, an electrical switch having a fixed contact electrically connected to one of a line coupler or a load coupler, and a movable contact electrically connected to the other of the line coupler and the load coupler. An actuator provides a rotational input to an operation assembly, which converts rotational movement of the actuator into linear movement of the movable contact to open or close the circuit between the line coupler and the load coupler. The electrical switchgear apparatus 10 is therefore a rotary-actuated linear switchgear apparatus. The operation assembly may include an energy storage assembly to store energy (e.g., in springs) as the actuator rotates, and then abruptly release the stored energy to rapidly drive the movable contact. A lockout assembly may be provided to prevent access to control structures, such as fuses, within the line coupler or load coupler when the contacts are closed.

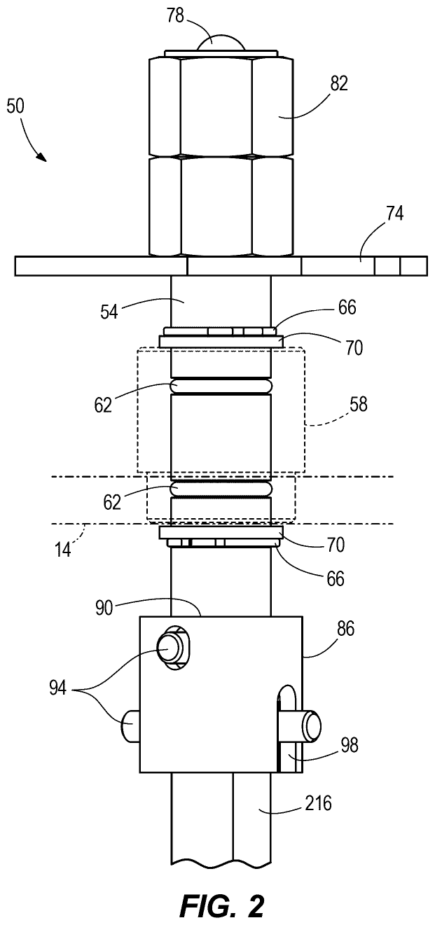

In more detail, the illustrated switchgear apparatus 10 includes an actuator 50 rotationally supported by the lid 14 and configured to control the electrical output of the switchgear apparatus 10 to the load circuits by opening or closing one or more electrical switches 200 (embodiments of which are shown starting at FIG. 5 and described in further detail below). Illustrated in FIG. 2, the actuator 50 includes an actuator shaft 54 that extends through a boss 58 fixed (e.g., welded) to the lid 14. The illustrated actuator 50 also includes a seal in the form of O-rings 62 (e.g., two O-rings) disposed on the actuator shaft 54 between the actuator shaft 54 and the boss 58 to maintain the interior of the electrical switchgear apparatus 10 in a sealed state relative to the exterior of the electrical switchgear apparatus 10. Snap rings 66 and washers 70 maintain the position of the actuator shaft 54 within the boss 58. An indicator 74 is positioned on the actuator shaft 54 toward the external end 78 of the actuator shaft 54 and a nut 82 is coupled to the external end 78. The indicator 74 and nut 82 are coupled with the actuator shaft 54 for rotation with the actuator shaft 54. In the present embodiment, the indicator 74 and actuator shaft 54 are coupled by a matching D-profile, although other coupling methods may be used instead (e.g., by a keyway, welding, etc.). The illustrated actuator 50 also includes a switch coupling 86 coupled to the internal end 90 of the actuator shaft 54 and to the electrical switch 200 (e.g., at the input shaft 216, also shown in FIG. 5) by a pair of coupling pins 94 that extend outwardly from the actuator shaft 54 and input shaft 216 through slots 98 in the switch coupling 86. To operate, that is, open or close, the electrical switch 200 to which the actuator 50 is coupled, a tool (e.g., a wrench or T-handle with a socket matching the profile of the nut 82) is placed on the nut 82 and rotated. In some embodiments, the actuator 50 may be provided with a handle.

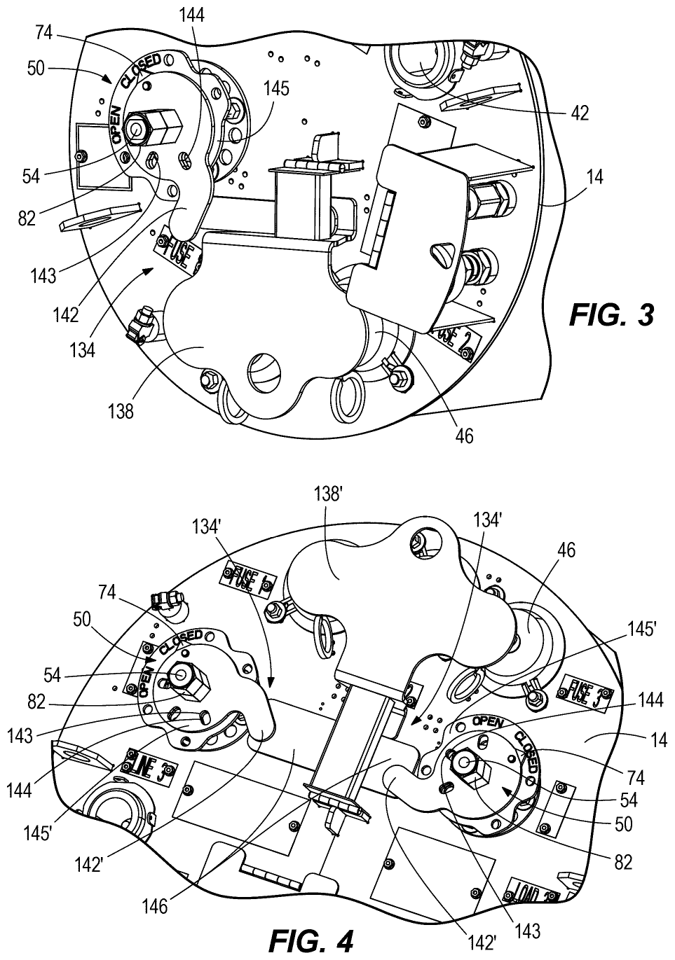

With reference to FIGS. 3-4, in some embodiments, the electrical switchgear apparatus 10 may include a lockout assembly 134 coupled to the lid 14. In the embodiment of FIG. 3 (e.g., a 1-phase, fused electrical switchgear apparatus 10), the lockout assembly 134 includes a lockout plate 138 that is pivotably coupled to the lid 14 and selectively disposed above the input couplers 46 to at least partially cover the input couplers 46, thereby preventing access to remove the control structure (e.g., fuse) within each input coupler 46. A lockout bar 142 is coupled to the nut 82 on the actuator shaft 54 for rotation with the actuator shaft 54. In the present embodiment, the lockout bar 142 is integrally formed with the indicator 74 as a unitary piece coupled to the actuator shaft 54. In other embodiments, the indicator 74 and lockout bar 142 may be separately formed.

In the embodiment of FIG. 4 (e.g., a 3-phase, fused electrical switchgear apparatus 10), the electrical switchgear apparatus 10 includes two electrical switches 200, and each electrical switch 200 includes an actuator 50 to which a lockout assembly 134′ is coupled. Each a lockout assembly 134′ includes a lockout plate 138′ and a lockout bar 142′. The lockout plate 138′ is pivotably coupled to the lid 14 and selectively disposed above the input couplers 46 to at least partially cover the input couplers 46. Lockout plate extensions 146 extend from the lockout bar 142′. The lockout bar 142′ of each lockout assembly 134′ is coupled to the actuator shaft 54 of each actuator 50 for rotation with the actuator shaft 54.

Returning to FIGS. 3-4, when the actuator shaft 54 and the associated electrical switch 200 are in a closed position (e.g., current can flow through the electrical switch 200), at least a portion of the lockout bar 142, 142′ is positioned above the lockout plate 138, 138′ and prevents rotation of the lockout plate 138, 138′ to uncover the input couplers 46. In the second embodiment of the lockout shaft of FIG. 4, the lockout bars 142′ are positioned above the lockout plate extensions 146. When the actuator shaft 54, and electrical switch 200 to which it is coupled, are in the open position (e.g., current cannot flow through the electrical switch 200), the lockout bar 142, 142′ does not cover the lockout plate 138, 138′, and the lockout plate 138, 138′ can be pivoted to uncover the input couplers 46 and allow access for removal and/or replacement of the control structures (e.g., fuses) within the input couplers 46. Other embodiments of lockout assemblies that physically prevent access to the input couplers 46 when the electrical switch 200 are in a closed position in which current can flow through the electrical switch 200 may be used instead. Other lockout mechanisms may be used in addition to or instead of the lockout assemblies described. In the embodiments of FIGS. 3-4, the lockout bar 142, 142′ includes a hole 143 that is alignable with the hole 144 of a safety plate 145, 145′ coupled (e.g., welded, fastened, etc.) to the lid 14. When the electrical switch 200 is in the open position, holes 143, 144 are aligned and a lock (e.g., a padlock) can be inserted into the holes 143, 144 and locked, preventing rotation of the lockout bar 142, 142′, that is, preventing inadvertent closing of the electrical switch 200, for instance, while the electrical switch 200 is being serviced.

FIG. 5 illustrates an embodiment of the electrical switch 200 coupled to an interior side 150 of the lid 14 (illustrated schematically) and positioned within the interior 154 of the housing 22. The line couplers 42 and input couplers 46 extend into the interior 154 and are electrically coupled to the electrical switch 200 by suitable connectors, such as copper wire rope, busbars, or the like. The illustrated electrical switch 200 includes an operation assembly 208 including a mounting plate 212 that is coupled to the lid 14 and an input shaft 216. The operation assembly 208 is operationally engaged with the actuator shaft 54 of the actuator 50 by the switch coupling 86, which is coupled to the input shaft 216. The electrical switchgear apparatus 10 may include bushings 220 that extend inward into the interior 154 of the housing 22 and are electrically coupled to the line couplers 42 and to the electrical switch 200 (e.g., by a connector).

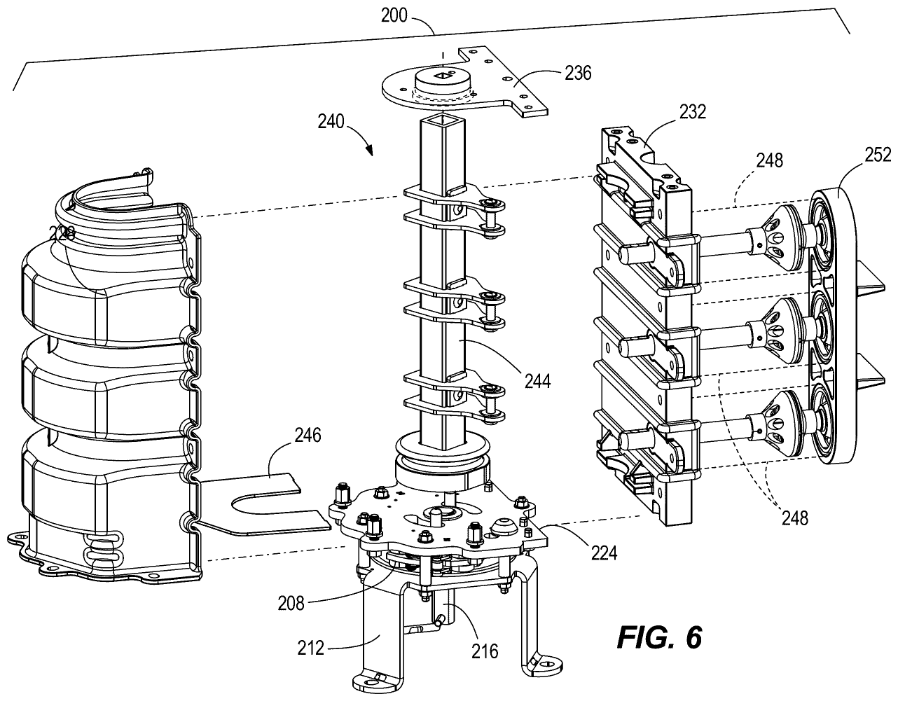

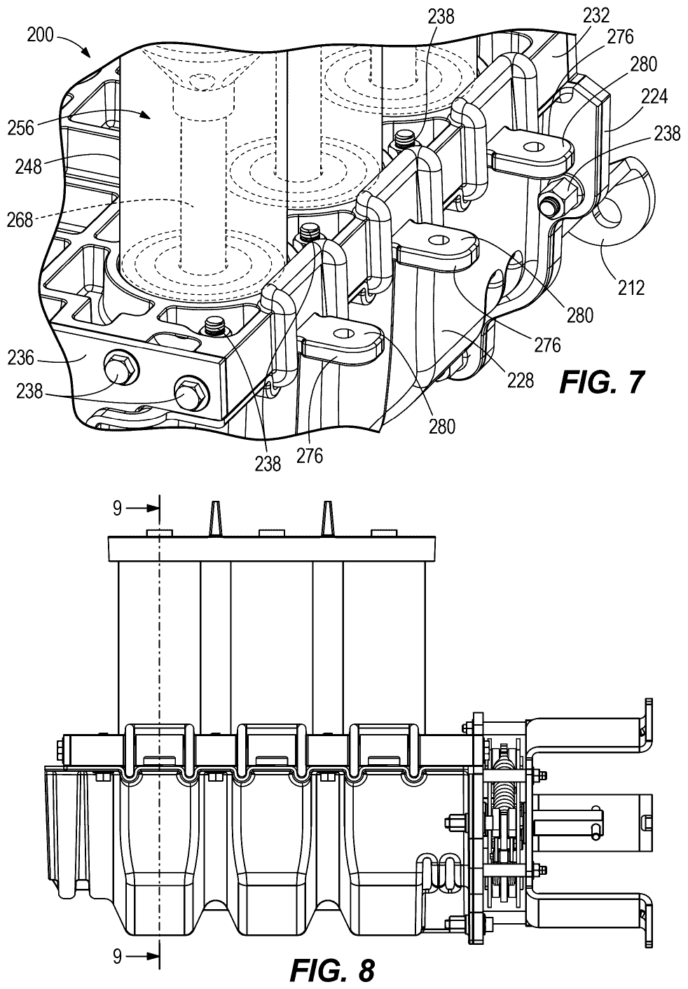

With reference to FIGS. 6-9, the operation assembly 208 of the illustrated electrical switch 200 is coupled to a base plate 224. A shell 228 and a base casting 232 are coupled to and extend from the base plate 224, and a top plate 236 is coupled to the shell 228 and base casting 232 opposite the base plate 224. The base plate 224, shell 228, base casting 232, and top plate 236 (coupled together by fasteners 238, shown in FIG. 7) cooperate to define an interior 240 through which a crankshaft 244 extends. Plates 246 are positioned in the interior 240 of the shell 228 at intervals along the crankshaft 244. The plates 246 each have a U-shaped cutout 247. The crankshaft 244 extends and is supported between the base plate 224 and top plate 236 and is operationally coupled to the operation assembly 208 to rotate in response to an output from the operation assembly 208 (FIG. 5). One or more chambers 248 (e.g., three chambers, each corresponding with a phase of a three-phase circuit) are coupled to the base casting 232 on the opposite side of the base casting 232 from the shell 228 offset from the middle of the base casting 232. The chambers 248 extend away from the base casting 232. The plurality of chambers 248 are open to (i.e., communicate) the housing interior I and are therefore filled with the insulating medium (e.g., CO2 gas, a combination of CO2 and oxygen (“02”), and/or other gases) contained within the housing interior I. In some embodiments, the housing interior I and chambers 248 may contain the insulating medium at a gauge pressure of at least 15 psi, or at least 20 psi in some embodiments. In other embodiments, other insulating gases and/or other fill pressures may be used. A top support 252 is coupled to the distal ends of the plurality of chambers 248 to define an internal compartment 256 of each chamber 248. The base plate 224, shell 228, base casting 232 may be composed of dielectric material that is not electrically conductive to prevent electrical discharge. Other shielding may be included to cover conductive components and prevent arcing or other electrical discharge.

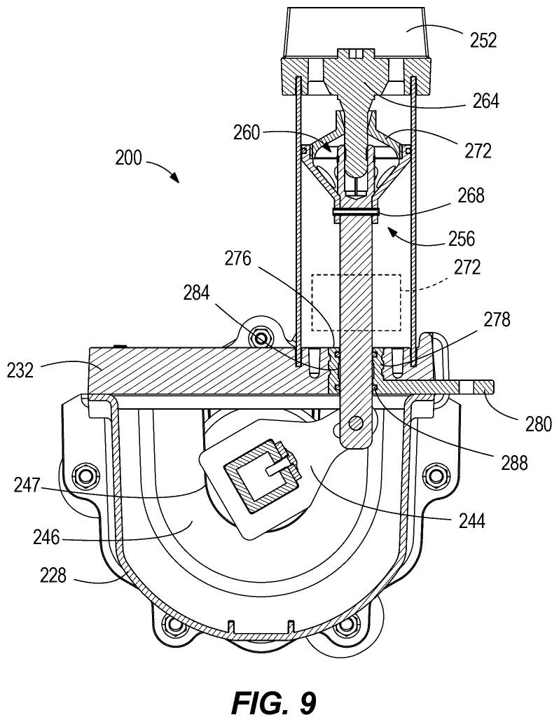

The electrical switch 200 includes pairs of contacts 260 that correspond to the number of chambers 248 (e.g., three pairs of contacts) in the electrical switch 200. Each pair of contacts 260 includes a first, stationary contact 264 that is coupled to the top support 252 and a second, movable contact 268 coupled to the crankshaft 244. A puffer nozzle 272 is coupled to the movable contact 268. Each stationary contact 264 is electrically coupled to one of the line couplers 42 or input couplers 46 by a connector 204 (shown in FIG. 5) to receive electrical current from a supply line or to transmit electrical current to a load line. With reference to FIG. 9, the movable contact 268 is linearly translatable within the chamber 248 between a closed position in which the movable contact 268 engages or is in contact with the stationary contact 264, and an open position (puffer nozzle 272 illustrated schematically in FIG. 9) in which the movable contact 268 is spaced from the stationary contact 264. When the movable contact 268 is in the closed position, current can flow between the stationary contact 264 and the movable contact 268.

As shown in FIGS. 7 and 9, the electrical switch 200 also includes sliding contacts 276 that are coupled to (e.g., cast or molded in) the base casting 232 through which the movable contacts 268 extend and are slidable. The sliding contacts 276 are configured to engage the movable contact 268 for electrical current exchange between the movable contact 268 and the sliding contacts 276. Each sliding contacts 276 includes a current exchange hub 278 and a tab portion 280 extending from the current exchange hub 278. The tab portion 280 is positioned between the shell 228 and the base casting 232 to extend beyond the outer surface of the shell 228 and base casting 232 and be electrically coupled (e.g., by one of the connectors 204) to one of the line couplers 42, input couplers 46, or another sliding contact 276 of a second electrical switch 200 in the electrical switchgear apparatus 10. The sliding contacts 276 also include one or more sliding electrical contacts 284 (e.g., two sliding electrical contacts, or lamina) that engage the movable contact 268 and a sleeve bushing 288. The plates 246 are positioned within the interior 240 of the shell 228, with the crankshaft 244 disposed within the U-shaped cutout 247 of each plate 246. The plates 246 electrically isolate the sliding contacts 276 from one another and from the base plate 224 and the top plate 236. In the present embodiment, plates 246 are positioned adjacent the base plate 224 and top plate 236 and between each sliding contact 276.

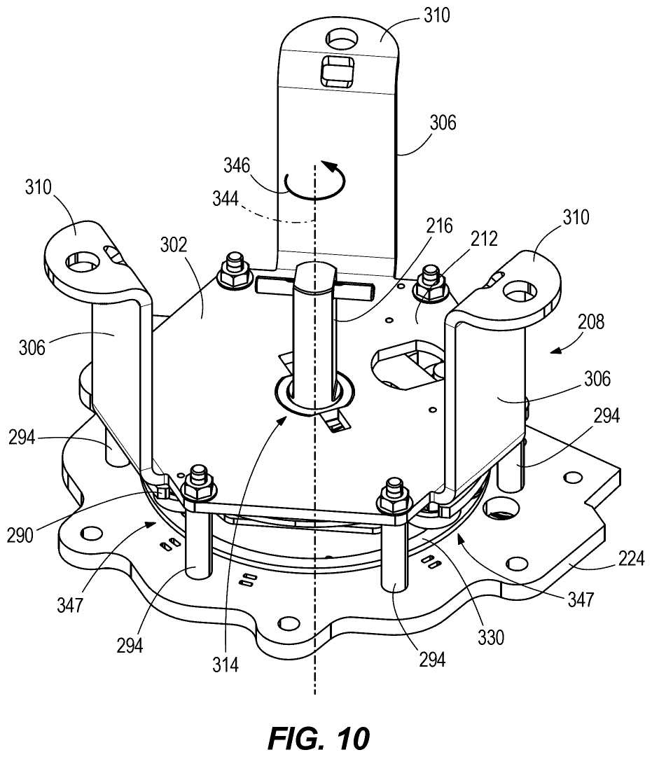

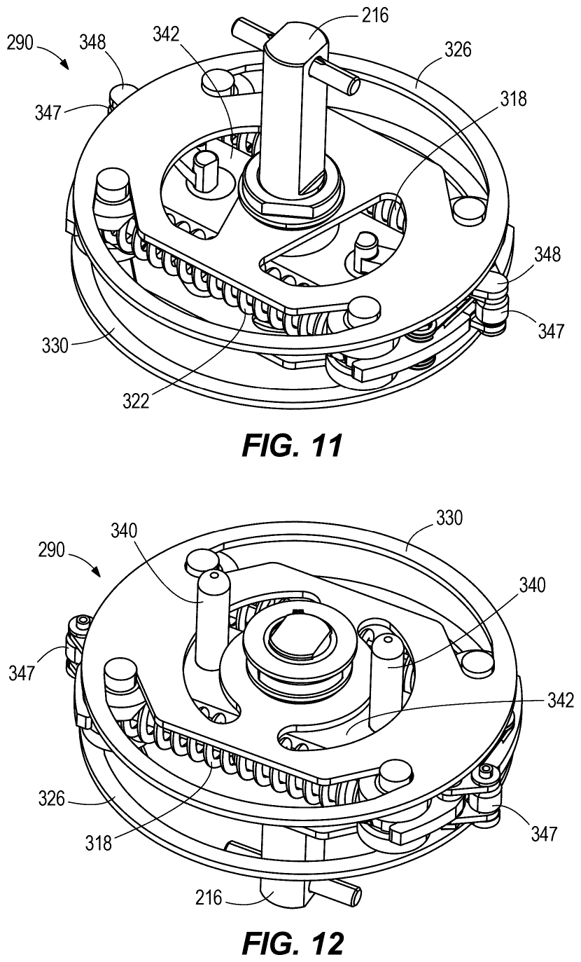

With reference to FIGS. 10-13, the operation assembly 208 includes the mounting plate 212 and an energy storage assembly 290 (FIGS. 11-13) coupled between the mounting plate 212 and the base plate 224. A plurality of standoffs 294 are coupled between the mounting plate 212 and the base plate 224 (e.g., by fasteners). The mounting plate 212 includes a planar plate portion 302 from which a plurality of legs 306 (e.g., three legs) extends. Each of the legs 306 include a tab portion 310 that is coupled to the inside of the lid 14. The plate portion 302 includes a hole 314 positioned substantially in the center of the plate portion 302 through which the input shaft 216 extends.

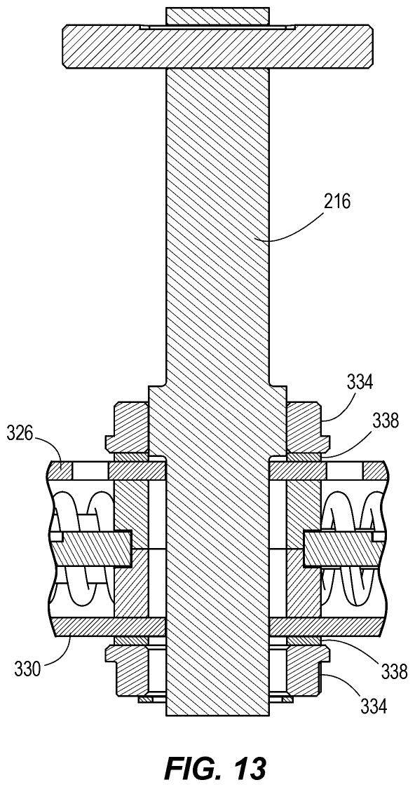

The energy storage assembly 290 receives a rotational input from the input shaft 216, to compress springs 318, 322 (e.g., as stored energy), which are supported in the energy storage assembly 290 by first and second plates 326, 330 when the stationary contacts 264 and the movable contacts 268 are engaged to close the circuit. The input shaft 216 is supported in the first and second plates 326, 330 by flanged bushings 334 and washers 338 (FIG. 13). The energy storage assembly 290 includes pins 340 coupled to a center plate 342 positioned between the first and second plates 326, 330 (FIG. 12). The pins 340 extend through the base plate 224 and are coupled to the crankshaft 244.

Rotation of the input shaft 216 in a first direction 346 about the rotational axis 344 to open the electrical switch 200 translates the movable contacts 268 from the closed position to the open position and releases the energy stored by the energy storage assembly 290 in the compressed springs 318, 322. Release of the energy stored in the springs rotates the pins 340 about the axis 344, and thereby rotates the crankshaft 244 to translate the movable contacts 268 to the open position. There is no motion until there is sufficient energy to operate the crankshaft 244 at the required rotational speed. This is achieved using interlock assemblies 347 coupled to the pins 340 and the center plate 342. The interlock assemblies 347 each include an interlock linkage 348 that engages one of the standoffs 294. The standoffs 294 hold the interlock linkages 348 in place during motion (e.g., rotation) of the center plate 342. As the center plate 342 pulls the interlock linkages 348 past the respective standoffs 294, the energy stored in the springs 318, 322 is released through the crankshaft 244. In other words, the energy stored in the springs 318, 322 when the stationary contacts 264 and movable contacts 268 are engaged to close the circuit assists to disengage the contacts 264, 268 and quickly open the circuit. The same interlock assemblies 347 automatically re-engage on the standoffs 294 at the end of the operation. Rotation of the input shaft 216 about the axis 344 in a opposite direction about the rotational axis 344, which corresponds with moving the movable contacts 268 into engagement with the stationary contacts 264 and closing the circuit, compresses the springs 318, 322.

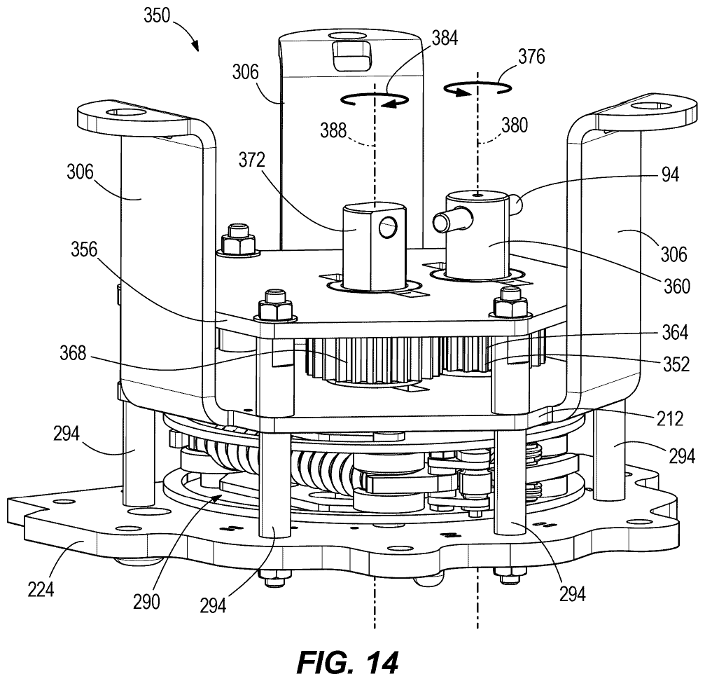

FIGS. 14-16 illustrate another embodiment of an operation assembly 350 (e.g., a reverse operation assembly) that transfers rotation from the actuator 50 to the crankshaft 244 in a direction opposite to the rotational direction of the actuator 50. Components of the operation assembly 350 that are identical to those of the previous embodiment of the operation assembly 208 will not be described.

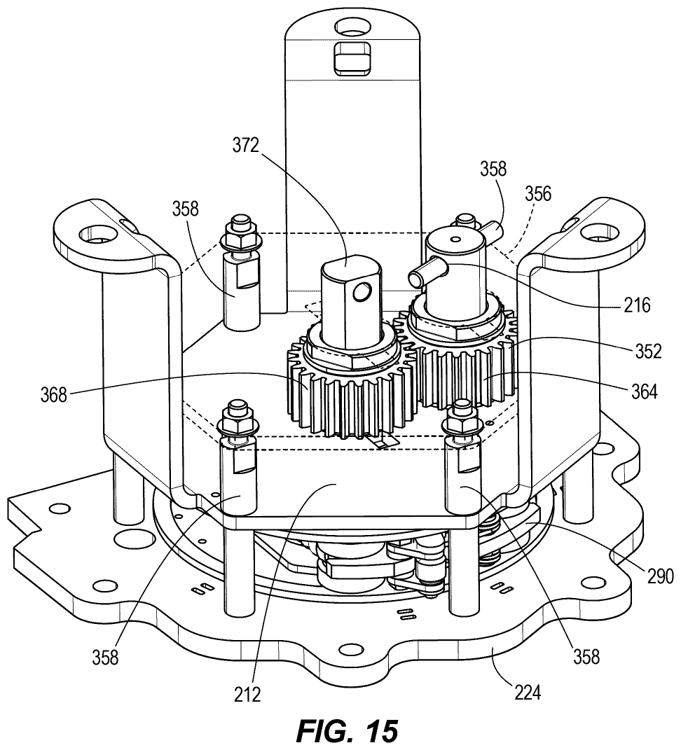

The operation assembly 350 includes a mounting plate 212 and an energy storage assembly 290 coupled between the mounting plate 212 and the base plate 224, and a plurality of standoffs 294 couple the mounting plate 212 to the base plate 224, substantially similar to operation assembly 208. The operation assembly 350 also includes a transmission assembly 352 (FIG. 15) positioned between the mounting plate 212 and a support plate 356 that is spaced from, and coupled, to the mounting plate 212 in a direction opposite the base plate 224 by standoffs 358. The support plate 356 is positioned between the plurality of legs 306 of the mounting plate 212. An input shaft 360 having coupling pins 94 is coupled to an actuator 50 and extends through the support plate 356. The transmission assembly 352 includes a drive pinion 364 that is coupled to the input shaft 360 for rotation with the input shaft 360 and a driven gear 368 supported on an output shaft 372 (e.g., a shaft similar to the input shaft 216). The output shaft 372 extends through the center of the support plate 356 and mounting plate 212 and is coupled to the energy storage assembly 290 to provide a rotational input to the energy storage assembly 290. The input shaft 360 is offset from the center of the support plate 356 and mounting plate 212.

The input shaft 360 receives a rotational input in a first direction 376 about the input shaft axis 380 from the actuator 50. The drive pinion 364 rotates with the input shaft 360, which in turn, rotates the driven gear 368 that is engaged (e.g., meshed) with the drive pinion 364. The driven gear 368 is thus rotated in a second direction 384 about the rotational axis 388 of the output shaft 372. Rotation of the output shaft 372 is transmitted to the energy storage assembly 290, which provides a rotational input to the crankshaft 244 in substantially the same manner as described above for the operation assembly 208. It will be appreciated that the operation assembly 350 can be used in place of operation assembly 208 to provide flexibility to optimize layout of the electrical switch 200 within the housing interior. It will also be appreciated that the operation assembly 350 can be included to communize operation electrical switchgear apparatus 10 having more than one electrical switch 200. For instance, in an embodiment of the electrical switchgear apparatus 10 having two electrical switches 200 (e.g., the embodiments of FIGS. 22, 25, 28, 31, described in greater detail below), by using on electrical switch 200 with operation assembly 208 and a second electrical switch electrical switch 200 with operation assembly 350, when opening or closing the circuits, the operator can rotate lockout bars 142, 142′ in the same rotational direction and the crankshafts 244 of each of the electrical switches 200 will rotated in opposite directions to open or close the circuits.

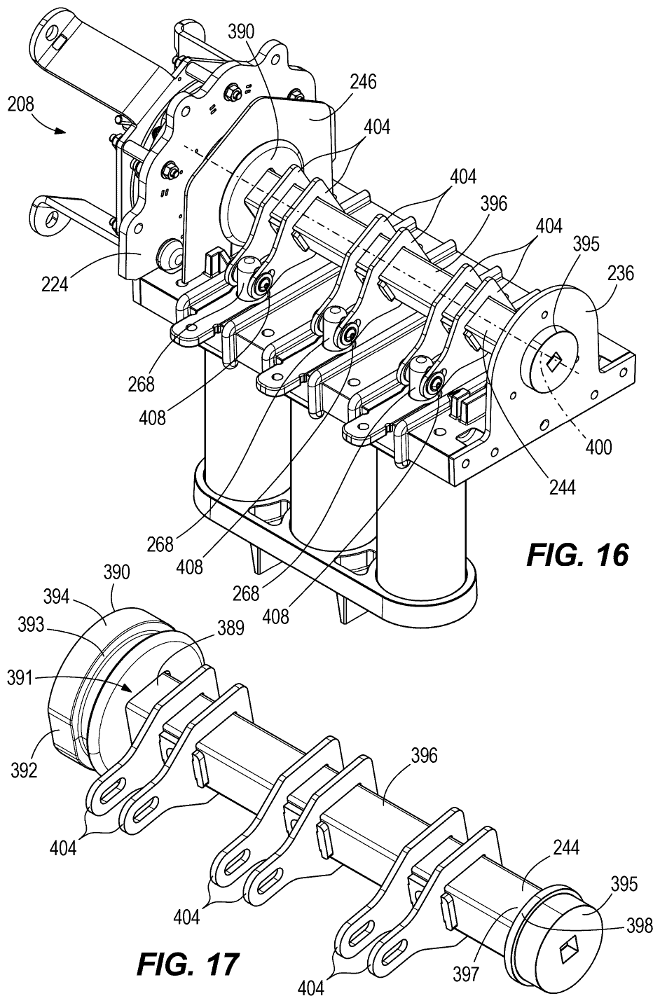

With reference to FIGS. 16-17, the crankshaft 244 is coupled to an operation assembly 208 (while not included in the embodiment, the crankshaft may instead be coupled to operation assembly 350). A first end 389 of the crankshaft 244 is positioned in a drive coupler 390 (e.g., fit within a bore 391 of the drive coupler 390 having a square cross-section). The drive coupler 390 includes flats 392 and a circumferential recess 393 formed on the outer circumference 394 of the drive coupler 390. The flats 392 selectively engages one or more switches (not shown) that provide a signal to indicate the position of the crankshaft 244 or other data. A plate 246 is partially positioned within the circumferential recess 393. The drive coupler 390 is coupled to the operation assembly 208, 350 by the pins 340 and driven by the operation assembly 208, 350 to rotate about the crankshaft axis 400. A bearing plate 395 is positioned on the second end 397 of the crankshaft 244. The bearing plate 395 includes a flange 398 that extends outward and engages the top plate 236 to position the bearing plate 395 and crankshaft 244 in the top plate 236. The drive coupler 390 and bearing plate 395 are composed of polypropylene or other dielectric material. Coupling plates 404 are spaced along the shaft portion 396 and are coupled to the movable contacts 268 by pins 408.

The electrical switch 200 is assembled by coupling the base plate 224 and operation assembly 208 with the base casting 232, positioning the drive coupler 390 and bearing plate 395 on the crankshaft 244, coupling the crankshaft 244 and drive coupler 390 to the base plate 224, positioning the top plate 236 with the bearing plate 395 to fit the crankshaft 244 and bearing plate 395 between the top plate 236 and base plate 224, coupling the top plate 236 to the base casting 232 (e.g., with four fasteners), positioning the plates 246 along the crankshaft 244, and coupling the shell 228 to the base casting 232. It will be appreciated that by assembling the components as described, the number of components to be assembled is reduced and the number of fastening operations required is also reduced, thereby reducing the manufacturing time.

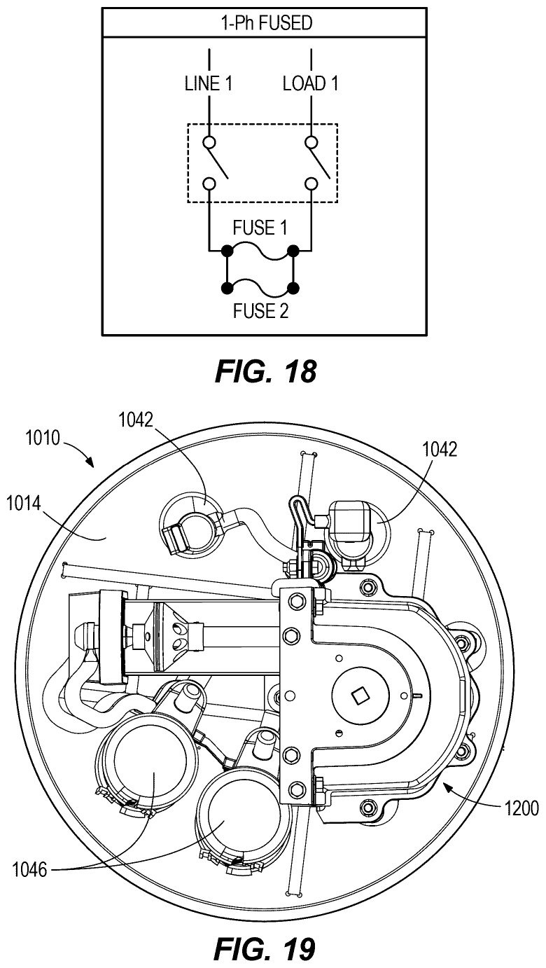

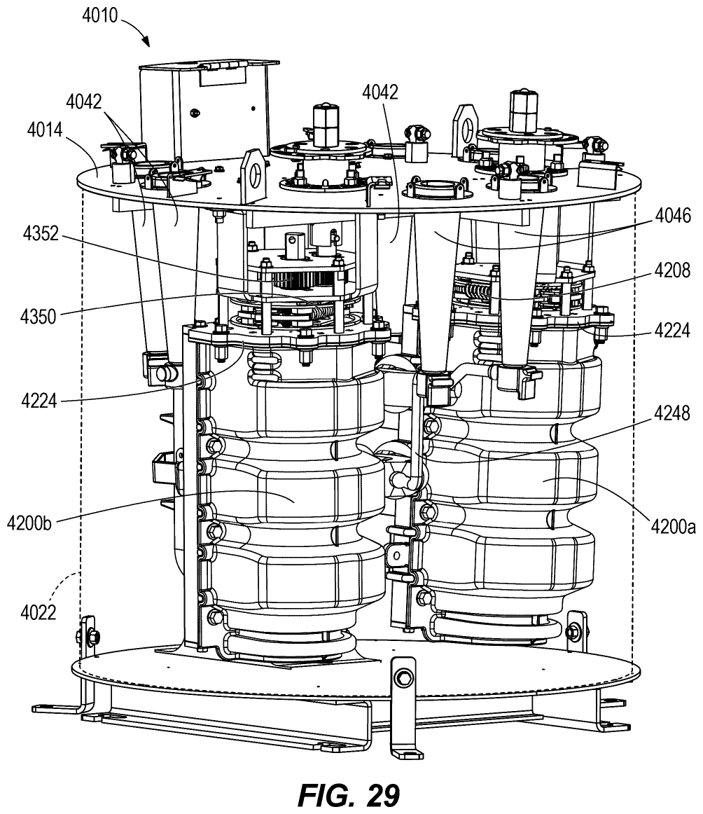

FIGS. 18-38 illustrate embodiments of different electrical switchgear apparatuses. Depending on the electrical layout of each embodiment, the switchgear assembly has either one or two electrical switch assemblies. The electrical switch assemblies are coupled to connectors extending inward into the interior of the housing by different busbars (e.g., a copper wire rope, a copper bus with insulation, a 2-layer bus, lamina-bus assemblies, etc.).

FIGS. 18-20 illustrate an embodiment of an electrical switchgear apparatus 1010 (e.g., a 1-phase, fused electrical switchgear apparatus), with like components and features as the embodiments of the electrical switchgear apparatus 10 shown in the previous figures being labeled with like reference numerals plus “1000.”

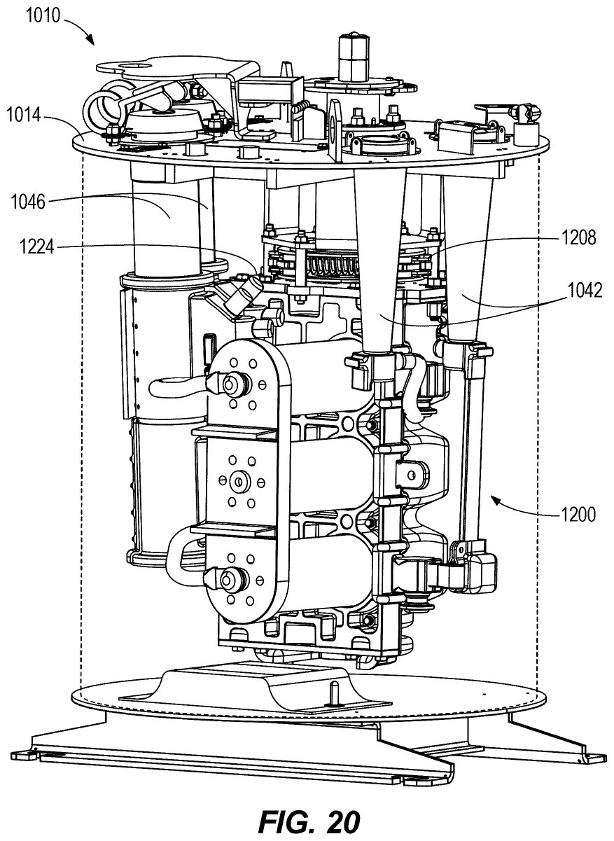

FIG. 18 illustrates the electrical circuit diagram for the electrical switchgear apparatus 1010. With reference to FIGS. 19-20, the electrical switchgear apparatus 1010 includes an electrical switch 1200 coupled to the lid 1014 and electrically coupled to line couplers 1042 and input couplers 1046 into which fuses are inserted. The electrical switch 1200 includes an operation assembly 1208 positioned between the base plate 1224 and the lid 1014. As shown in FIGS. 19 and 20, the electrical switchgear apparatus 1010 is a one-phase switchgear apparatus that uses two switches (e.g., the stationary contact 264 and movable contact 268), with a fuse coupled between the stationary contacts 264.

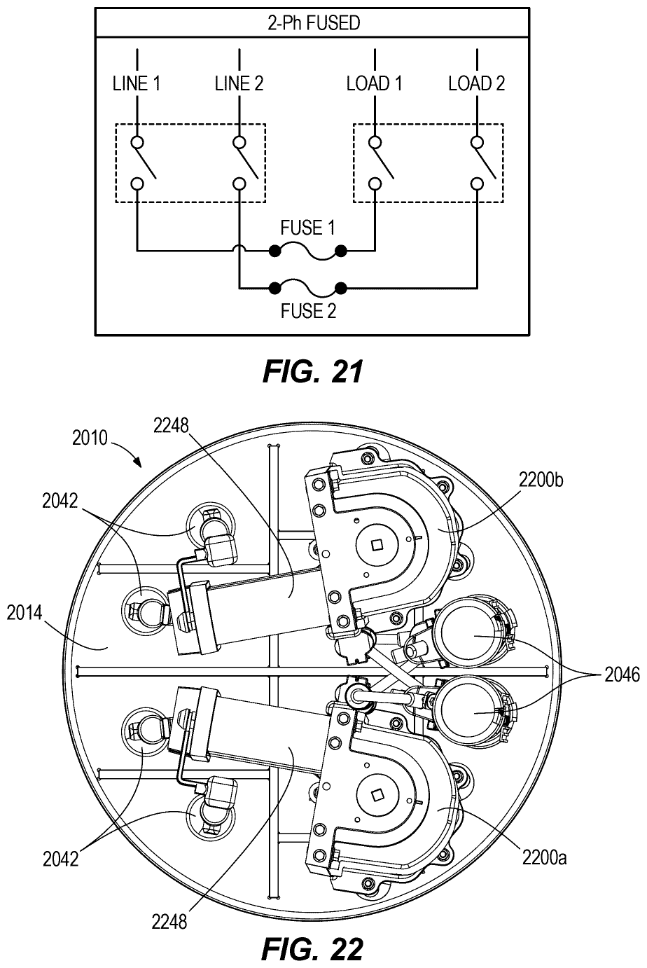

FIGS. 21-23 illustrate an embodiment of an electrical switchgear apparatus 2010 (e.g., a 2-phase, fused electrical switchgear apparatus), with like components and features as the embodiments of the electrical switchgear apparatus 10 shown in the previous figures being labeled with like reference numerals plus “2000.”

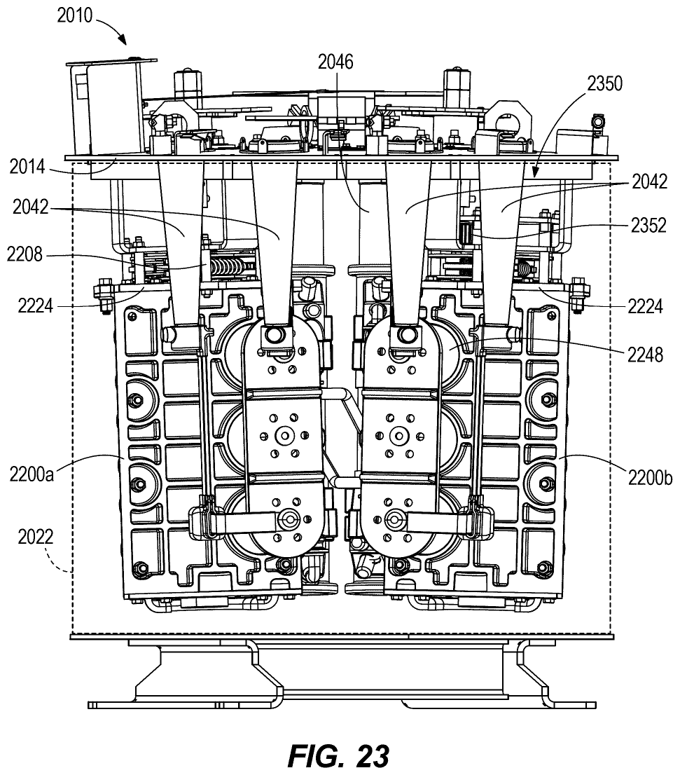

FIG. 21 illustrates the electrical circuit diagram for the electrical switchgear apparatus 2010. With reference to FIGS. 22-23, the electrical switchgear apparatus 2010 includes two electrical switches 2200a, 2200b coupled to the lid 2014 and electrically coupled to the line couplers 2042 and the input couplers 2046 into which fuses are inserted. The first electrical switch 2200a includes an operation assembly 2208 positioned between the base plate 2224 and the lid 2014 and the chambers 2248 are positioned toward the center of the housing 2022. The second electrical switch 2200b includes an operation assembly 2350 with a transmission assembly 2352 positioned between the base plate 2224 and the lid 2014 and the chambers 2248 are also positioned toward the center of the housing 2022.

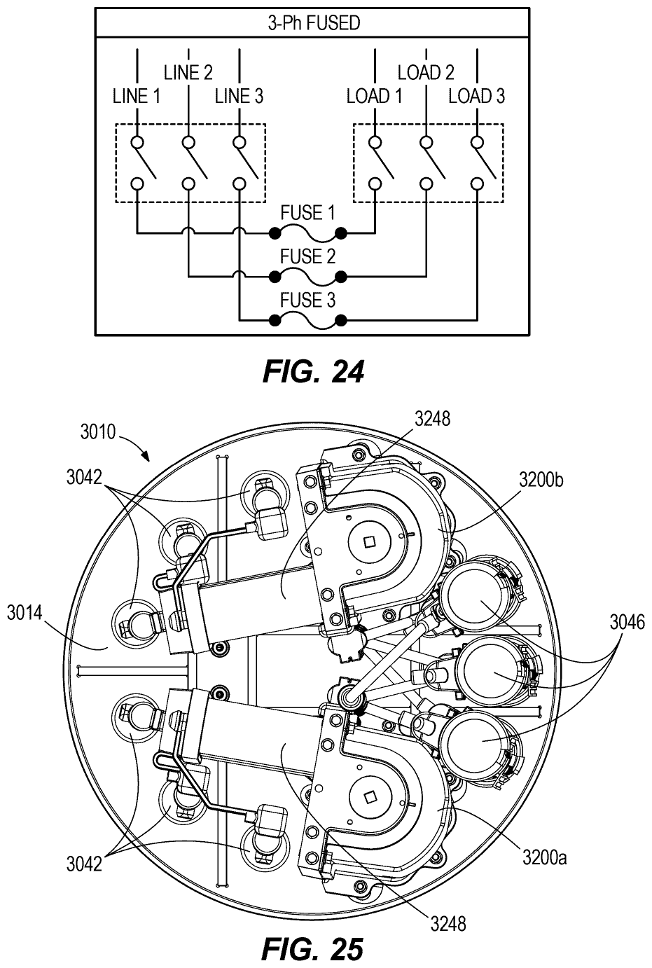

FIGS. 24-26 illustrate an embodiment of an electrical switchgear apparatus 3010 (e.g., a 3-phase, fused electrical switchgear apparatus), with like components and features as the embodiments of the electrical switchgear apparatus 10 shown in the previous figures being labeled with like reference numerals plus “3000.”

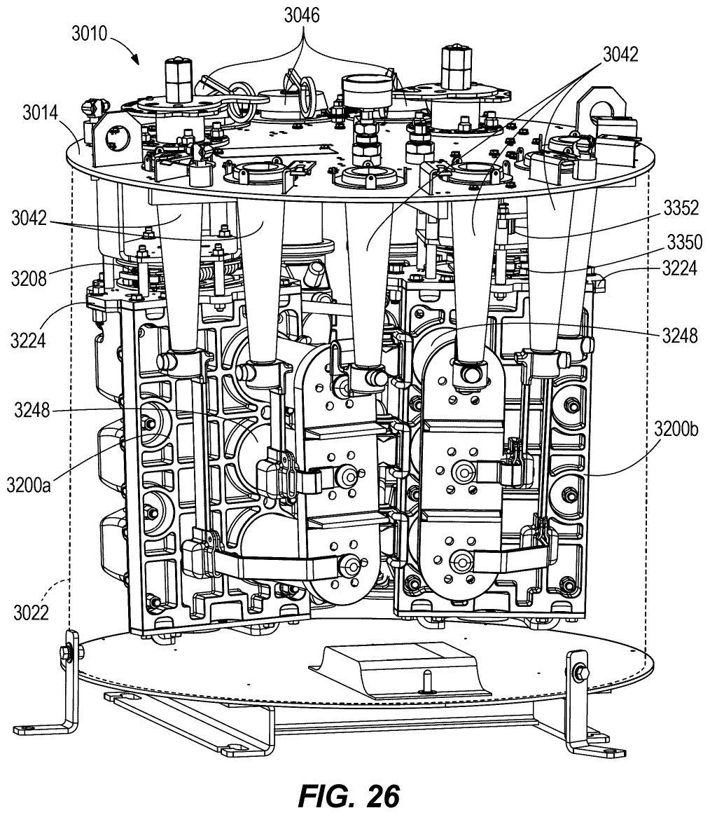

FIG. 24 illustrates the electrical circuit diagram for the electrical switchgear apparatus 3010. With reference to FIGS. 25-26, the electrical switchgear apparatus 3010 includes two electrical switches 3200a, 3200b coupled to the lid 3014 and electrically coupled to the line couplers 3042 and the input couplers 3046, into which fuses are inserted. The first electrical switch 3200a includes an operation assembly 3208 positioned between the base plate 3224 and the lid 3014 and the chambers 3248 are positioned toward the center of the housing 3022. The second electrical switch 3200b includes an operation assembly 3350 with a transmission assembly 3352 positioned between the base plate 3224 and the lid 3014 and the chambers 3248 are also positioned toward the center of the housing 3022.

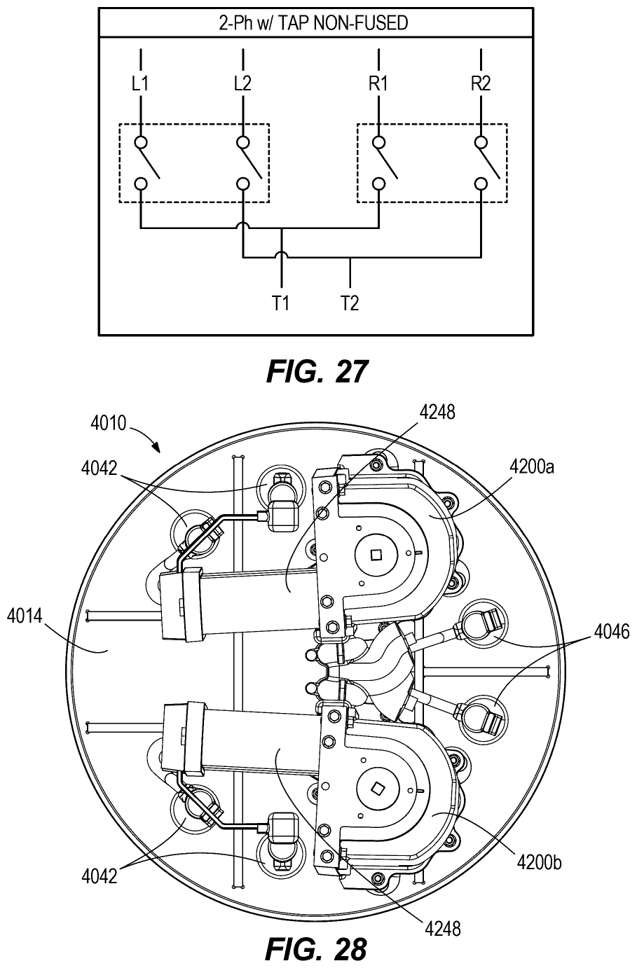

FIGS. 27-29 illustrate an embodiment of an electrical switchgear apparatus 4010 (e.g., a 2-phase, non-fused, tapped electrical switchgear apparatus), with like components and features as the embodiments of the electrical switchgear apparatus 10 shown in the previous figures being labeled with like reference numerals plus “4000.”

FIG. 27 illustrates the electrical circuit diagram for the electrical switchgear apparatus 4010. With reference to FIGS. 28-30, the electrical switchgear apparatus 4010 includes two electrical switches 4200a, 4200b coupled to the lid 4014 and electrically coupled to the line couplers 4042 and the input couplers 4046 (e.g., voltage taps). The first electrical switch 4200a includes an operation assembly 4208 positioned between the base plate 4224 and the lid 4014 and the chambers 4248 are positioned toward the center of the housing 4022. The second electrical switch 4200b includes an operation assembly 4350 with a transmission assembly 4352 positioned between the base plate 4224 and the lid 4014 and the chambers 4248 are also positioned toward the center of the housing 4022.

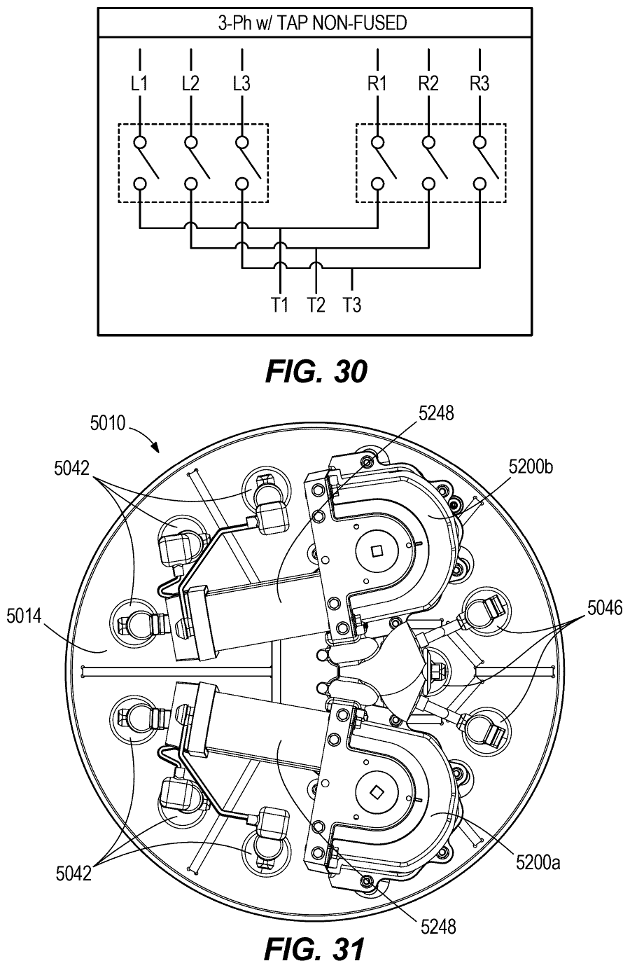

FIGS. 30-32 illustrate an embodiment of an electrical switchgear apparatus 5010 (e.g., a 3-phase, non-fused, tapped electrical switchgear apparatus), with like components and features as the embodiments of the electrical switchgear apparatus 10 shown in the previous figures being labeled with like reference numerals plus “5000.”

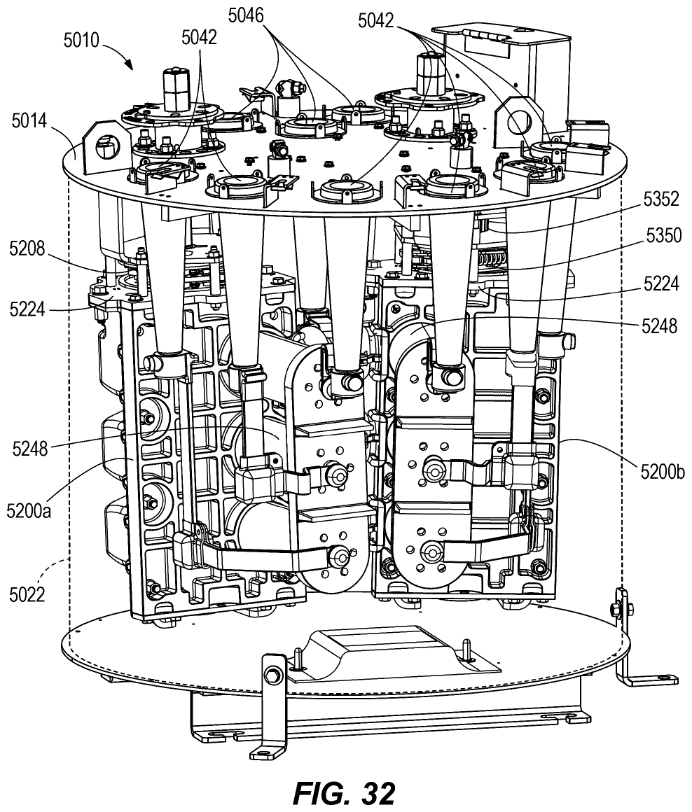

FIG. 30 illustrates the electrical circuit diagram for the electrical switchgear apparatus 5010. With reference to FIGS. 31-32, the electrical switchgear apparatus 5010 includes two electrical switches 5200a, 5200b coupled to the lid 5014 and electrically coupled to the line couplers 5042 and the input couplers 5046 (e.g., voltage taps). The first electrical switch 5200a includes an operation assembly 5208 positioned between the base plate 5224 and the lid 5014 and the chambers 5248 are positioned toward the center of the housing 5022. The second electrical switch 4200b includes an operation assembly 5350 with a transmission assembly 5352 positioned between the base plate 5224 and the lid 5014 and the chambers 5248 are also positioned toward the center of the housing 5022.

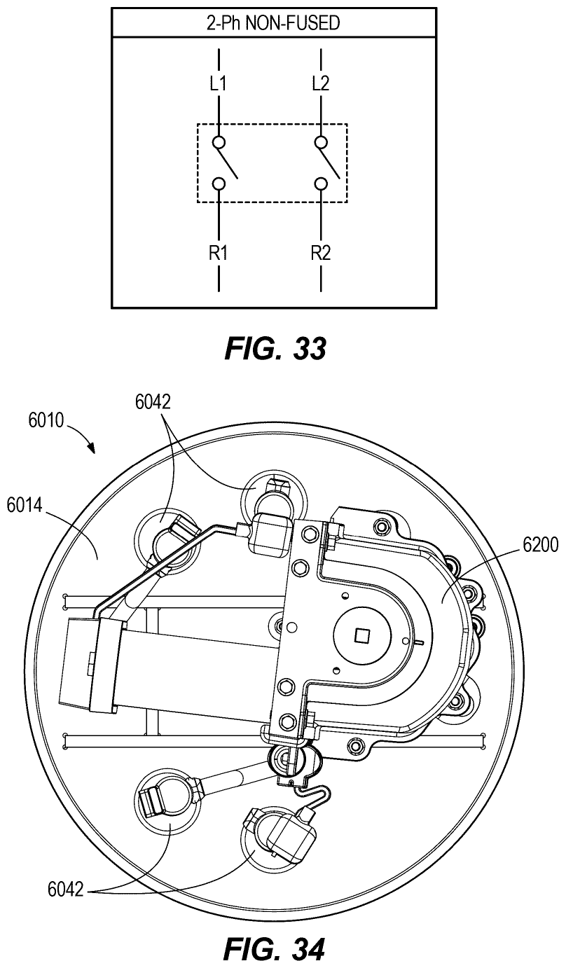

FIGS. 33-35 illustrate an embodiment of an electrical switchgear apparatus 6010 (e.g., a 2-phase, non-fused electrical switchgear apparatus), with like components and features as the embodiments of the electrical switchgear apparatus 10 shown in the previous figures being labeled with like reference numerals plus “6000.”

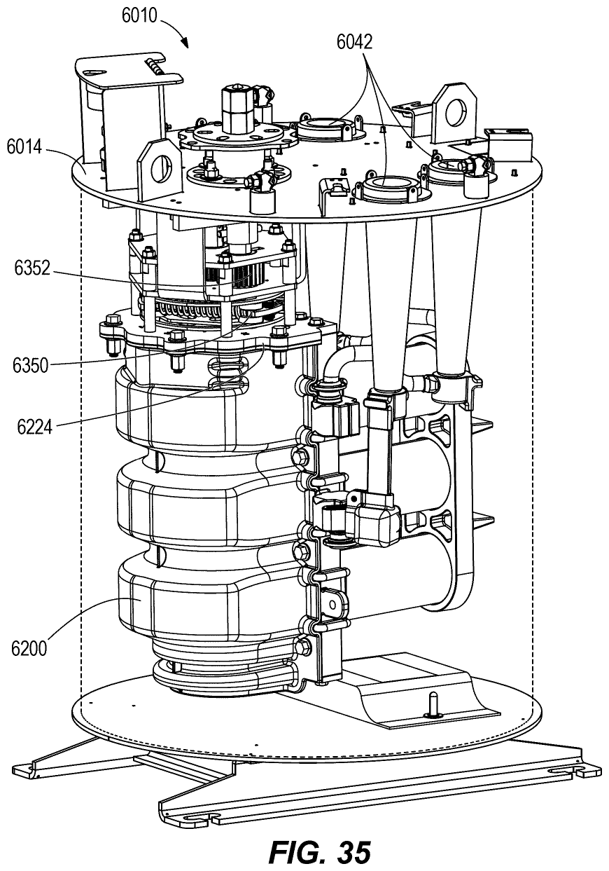

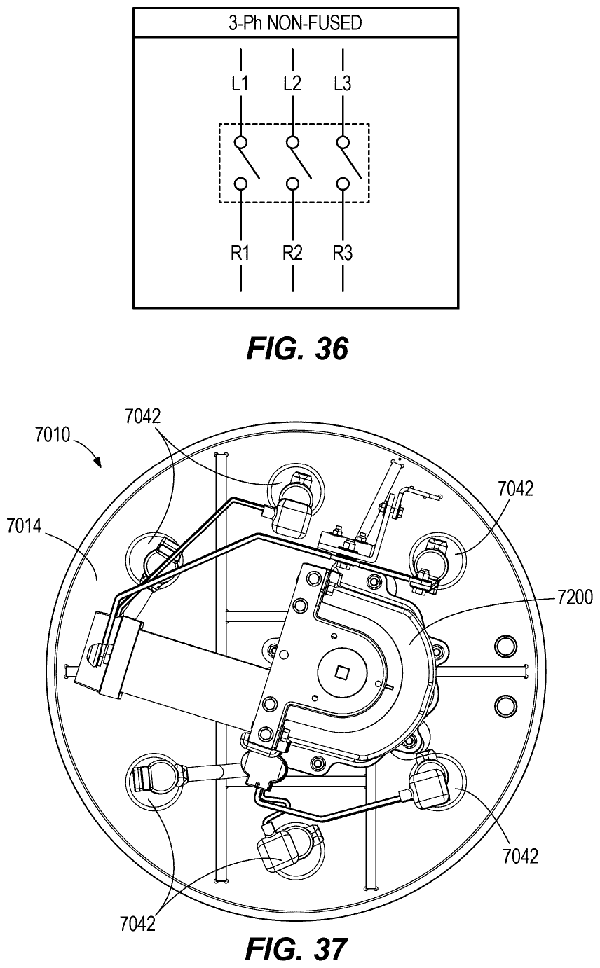

FIG. 33 illustrates the electrical circuit diagram for the electrical switchgear apparatus 6010. With reference to FIGS. 35-36, the electrical switchgear apparatus 6010 includes an electrical switch 6200 coupled to the lid 6014 and electrically coupled to line couplers 6042. The electrical switch 6200 includes an operation assembly 6350 with a transmission assembly 6352 positioned between the base plate 6224 and the lid 6014.

FIGS. 36-38 illustrate an embodiment of an electrical switchgear apparatus 7010 (e.g., a 3-phase, non-fused electrical switchgear apparatus), with like components and features as the embodiments of the electrical switchgear apparatus 10 shown in the previous figures being labeled with like reference numerals plus “7000.”

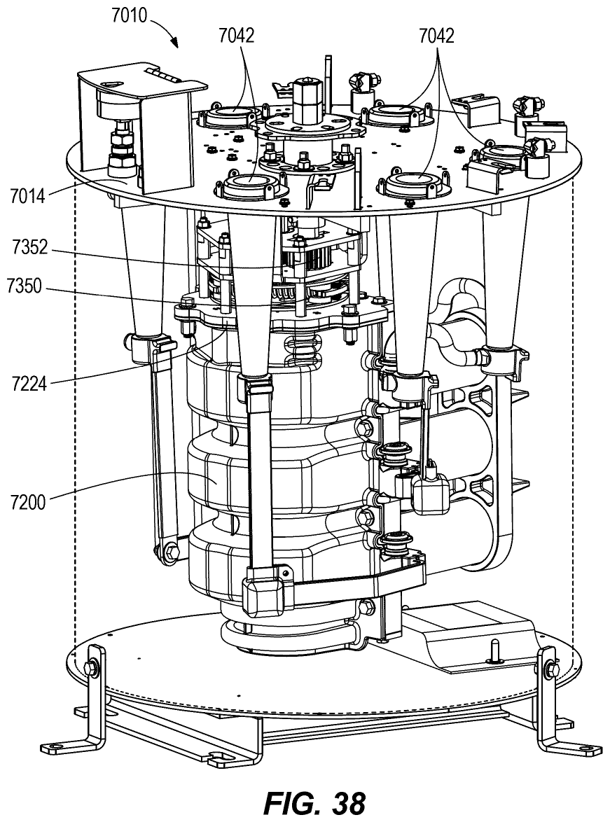

FIG. 36 illustrates the electrical circuit diagram for the electrical switchgear apparatus 7010. With reference to FIGS. 37-38, the electrical switchgear apparatus 7010 includes an electrical switch 7200 coupled to the lid 7014 and electrically coupled to line couplers 7042. The electrical switch 7200 includes an operation assembly 7350 with a transmission assembly 7352 positioned between the base plate 7224 and the lid 7014.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A switchgear apparatus comprising:
a cylindrical housing defining a housing interior filled with a non-SF6 gas;
an electrical switch supported within the housing, the electrical switch including a chamber communicating the housing interior and a pair of contacts within the chamber, the pair of contacts including a stationary contact and a movable contact;
a crankshaft coupled to the movable contact such that the movable contact is configured to translate linearly relative to the stationary contact in response to rotation of the crankshaft.

2. The switchgear apparatus of claim 1, wherein the electrical switch is a first electrical switch, and wherein the switchgear apparatus further comprises a second electrical switch supported within the housing.

3. The switchgear apparatus of claim 2, wherein the crankshaft is a first crankshaft, and wherein the switchgear apparatus further comprises a second crankshaft coupled to a movable contact of the second electrical switch.

4. The switchgear apparatus of claim 3, wherein the first crankshaft is rotatable in a first direction to move the movable contact of the first electrical switch away from the stationary contact of the first electrical switch, and wherein the second crankshaft is rotatable in a second direction to move the movable contact of the second electrical switch away from a stationary contact of the second electrical switch.

5. The switchgear apparatus of claim 4, wherein the second direction is opposite the first direction.

6. The switchgear apparatus of claim 1, wherein the non-SF6 gas is carbon dioxide.

7. The switchgear apparatus of claim 6, wherein the housing is filled with carbon dioxide to a gauge pressure of at least 15 psi.

8. The switchgear apparatus of claim 7, wherein the housing is filled with carbon dioxide to a gauge pressure of at least 20 psi.

9. The switchgear apparatus of claim 1, wherein the housing has an interior volume that is less than 500 liters.

10. The switchgear apparatus of claim 9, wherein the interior volume is less than 300 liters.

11. The switchgear apparatus of claim 10, wherein the interior volume is less than 150 liters.

12. A switchgear apparatus comprising:
an apparatus housing including a base casting coupled to a shell, a top plate, and a base plate, the top plate and base plate coupled to opposite ends of the base casting;
a crankshaft rotationally supported between the top plate and the base plate;
an operation assembly configured to provide a rotational output to the crankshaft;
a plurality of chambers coupled to the base casting and extending from the base casting away from the shell;
a top support coupled to distal ends of the chambers, the top support configured to seal the distal ends of the chambers;
a plurality of contact pairs supported in each chamber, each contact pair including a stationary contact and a movable contact, each stationary contact is coupled to the top support and each movable contact is coupled to the crankshaft, each movable contact configured to translate linearly along the chamber in response to rotation of the crankshaft.

13. The switchgear apparatus of claim 12, wherein each of the chambers is filled with a non-SF6 gas.

14. The switchgear apparatus of claim 12, wherein the operation assembly includes an input shaft coupled to the crankshaft and configured to provide the rotational output to the crankshaft, the input shaft configured to receive a rotational input from an operator, the rotational input having a first direction.

15. The switchgear apparatus of claim 14, wherein the operation assembly further includes a transmission assembly configured to receive the rotational input in the first direction and provide the rotational output to the crankshaft in a second direction opposite to the first direction.

16. The switchgear apparatus of claim 15, wherein the transmission assembly includes a pinion coupled to the input shaft and a driven gear coupled to an output shaft, the output shaft coupled to the crankshaft.

17. A switchgear apparatus comprising:
a housing defining a housing interior containing an insulating medium;
a lid coupled to the housing and the lid defining an interior;
a plurality of connectors extending from the lid into the interior; and
an electrical switch coupled to the lid and electrically coupled to the connectors, the electrical switch including
an apparatus housing including a base casting coupled to a shell, a top plate, and a base plate, the top plate and base plate coupled to opposite ends of the base casting,
a crankshaft rotationally supported between the top plate and the base plate,
an operation assembly coupled to the base plate and configured to provide a rotational output to the crankshaft,
a plurality of chambers coupled to the base casting and extending from the base casting away from the shell,
a top support coupled to distal ends of the chambers, the top support configured to seal the distal ends of the chambers, and
a plurality of contact pairs supported in each chamber, each contact pair including a stationary contact and a movable contact, each stationary contact is coupled to the top support and each movable contact is coupled to the crankshaft, each movable contact configured to translate linearly along the chamber in response to rotation of the crankshaft.

18. The switchgear apparatus of claim 17, wherein the electrical switch is a first electrical switch, the switchgear apparatus including a second electrical switch.

19. The switchgear apparatus of claim 17, wherein the operation assembly includes a transmission assembly configured to receive a rotational input in a first direction and provide the rotational output to the crankshaft in a second direction opposite to the first direction.

20. The switchgear apparatus of claim 19, wherein the transmission assembly includes a pinion coupled to an input shaft and a driven gear coupled to an output shaft, the output shaft coupled to the crankshaft.
